(19) United States
(12) Patent Application Publication
(10) Pub. No.: US 2015/0125122 A1
(43) Pub. Date: May 7, 2015

(54) GRAPHENE COATED FIBER OPTICS

(71) Applicant: TYSON YORK WINARSKI, Mountain View, CA (US)

(72) Inventor: TYSON YORK WINARSKI, Mountain View, CA (US)

(21) Appl. No.: 14/070,574

(22) Filed: Nov. 3, 2013

(51) Int. Cl. G02B 6/02

(52) U.S. Cl. CPC G02B 6/02
USPC 385/123

(57) ABSTRACT

A graphene coated optic fiber is disclosed that includes an optic fiber encapsulated within a graphene capsule. This graphene capsule may comprise a single layer of graphene or multiple layers of graphene. A graphene coated optic fiber is disclosed that includes a graphene end cap to protect and end portion of the optic fiber.

This application claims the benefit of U.S. Provisional Application No. 61/701,722, filed Sep. 17, 2012, which is hereby incorporated by reference, as well as U.S. patent application Ser. No. 13/887,322, which is also hereby incorporated by reference.

### BACKGROUND

Fiber optic cables are favored for modern data communication. Fiber optic cable offers large bandwidth for high-speed data transmission. Signals can be sent farther than across copper cables without the need to “refresh” or strengthen the signal. Fiber optic cables offer superior resistance to electromagnetic noise, such as from adjoining cables. In addition, fiber optic cables require far less maintenance than metal cables, thereby making fiber optic cables more cost effective.

Optical fiber is made of a core that is surrounded by a cladding layer. The core is the physical medium that transports optical data signals from an attached light source to a receiving device. The core is a single continuous strand of glass or plastic that is measured (in microns) by the size of its outer diameter. The larger the core, the more light the cable can carry. All fiber optic cable is sized according to its core diameter. The three diameters of the most commonly available multimode cores are 50-micron, 62.5-micron, and 100-micron, although single-mode cores may be as small as 8-10 microns in diameter. The cladding is a thin layer that surrounds these micrometer sized fiber cores. It is the core-cladding boundary that contains the light waves within the core by causing the high-angle reflection as measured relative to a line perpendicular to this boundary, such as a core-diametral line, enabling data to travel throughout the length of the fiber segment. Typically, the core and cladding are made of high-purity silica glass. The light signals remain within the optical fiber core due to total or near-total internal reflection within the core, which is caused by the difference in the refractive index between the cladding and the core.

The cladding is typically coated with a layer of acrylate polymer or polymide, thereby forming an insulating jacket. This insulating jacket protects the optic fiber from damage. This coating also reinforces the optic fiber core, absorbs mechanical shocks, and provides extra protection against excessive cable bends. These insulating jacket coatings are measured in microns and typically range from 250 microns to 900 microns.

Strengthening fibers are then commonly wrapped around the insulating jacket. These fibers help protect the core from crushing forces and excessive tension during installation. The strengthening fibers can be made of KEVLART″ for example. An outer cable jacket is then provided as the outer layer of the cable. The outer cable jacket surrounds the strengthening fibers, the insulating jacket, the cladding and the optic fiber core. Typically, the outer cable jacket is colored orange, black, or yellow.

A fiber optic communications network includes a multitude of fiber optic connections. At these connections, the ends of two different fiber optic cables are coupled together to facilitate the transmission of light between them. At these ends of the fiber optic cables, the optic fiber core and cladding is exposed to the environment. When the ends of the optic fiber core and cladding are free of damage, dirt, or debris, light is transmitted clearly between the two fiber optic cables. However, if either of the fiber optic cable ends has damage to the optic fiber core or cladding, the damage can prevent the transmission of light, causing back reflection, insertion loss, and damage to other network components. Typically, most fiber optic connectors are not inspected for damage until after a transmission problem is detected, which is often after permanent damage has been caused to other fiber optic equipment. In addition, micrometer sized optic fibers can suffer damage along the length of the fiber.

Optic fibers are also known to have diameters in the nanometer range. These fibers are extremely delicate and fragile, not just on their ends like conventional micrometer sized fibers discussed above, but also along their length as well.

It is therefore desirable to develop technologies that can prevent damage to the ends of optic fibers to ensure the clear transmission of light signals at connections between different optic fibers and their supporting opto-electronics. It is therefore also desirable to develop technologies that can protect and strengthen optic fibers along the lengths of the fiber to prevent damage.

### SUMMARY

A fiber optic cable is disclosed that includes an optic fiber. An optic fiber, geometrically, is a solid cylinder having flat end-surfaces. A graphene layer may cover one or both of these flat end-surfaces of the optic fiber for wear protection. A graphene layer may also cylindrically cover the optic fiber along its longitudinal axis for wear protection, thereby forming a graphene tube, commonly referred to as a carbon nanotube or carbon nanofiber. Together, the graphene covering both end-surfaces and the graphene cylindrically covering the length of the optic fiber may be bonded together to encapsulate the optic fiber in a graphene capsule via carbon-carbon bonds.

Grahpene is a hard material that is 97.7% optically transparent. Graphene is a flat monolayer of carbon atoms that are tightly packed into a two-dimensional lattice, thereby forming a sheet of graphene. Graphene is 97.7% optically transparent. Thus, light can pass through a graphene layer for purposes of data transmission within an optic fiber communications network. Graphene is an extremely strong material due to the covalent carbon-carbon bonds. It is desirable to utilize graphene lattices that are defect free as the presence of defects reduces the strength of graphene lattice. The intrinsic strength of a defect free sheet of graphene is 42 Nm⁻¹, making it one of the strongest materials known. The strength of graphene is comparable to the hardness of diamonds. As such, graphene is an effective material for wear protection. Further, graphene is highly flexible.

A graphene coated optic-fiber is disclosed. The graphene coated optic-fiber includes a silica optic fiber and a tubular layer of graphene surrounding a length of the optic fiber. The tubular layer of graphene is deposited, or grown, on the optic fiber through a Chemical Vapor Deposition (CVD) process. Due to the strength and flexibility of graphene, the tubular layer of graphene provides mechanical support and wear protection while enabling the silica optic fiber to remain flexible.

The tubular layer of graphene may be formed of a single layer of graphene or multiple layers of graphene. The silica optic fiber is formed of a solid cylinder that has flat end surfaces. These flat end surfaces may be covered with planar sheets of graphene deposited through a Chemical Vapor Deposition (CVD) process. In one embodiment, these planar sheets of graphene are attached to the tubular layer of graphene via carbon-carbon bonds, thereby encapsulating the optic fiber in a graphene capsule.

The graphene coated optic-fiber may further include silica cladding. The silica cladding surrounds the silica optic fiber. In this embodiment, the tubular layer of graphene surrounds the silica cladding. Due to the strength and flexibility of graphene, the tubular layer of graphene provides mechanical support and wear protection while enabling the silica optic fiber and silica cladding to remain flexible. In this embodiment, the optic fiber and said silica cladding have coplanar end-surfaces. These coplanar end surfaces are covered with a planar sheet of graphene deposited through said Chemical Vapor Deposition (CVD) process. These planar sheets of graphene may be attached to the tubular layer of graphene via carbon-carbon bonds, thereby encapsulating said silica optic fiber and said silica cladding in a graphene capsule. The use of silica cladding to support the silica optic fiber is optional. In one embodiment, the tubular layer of graphene functions as a cladding layer around said silica optic fiber due to the difference in indices of refraction of silica and graphene. It is contemplated that the silica optic fiber may have a wide range of diameters. For example, the silica optic fiber may comprise a nanofiber. Alternatively, silica optic fiber may be formed of a micrometer sized fiber.

A graphene coated optic-fiber is disclosed. The graphene coated optic fiber is formed of a silica optic-fiber encapsulated in a graphene capsule. This graphene coated optic-fiber may also include silica cladding. The silica cladding cylindrically surrounds the silica optic fiber along its length within the graphene capsule. In one embodiment, the graphene capsule is formed through depositing graphene on the silica optic-fiber through a Chemical Vapor Deposition (CVD) process. In another embodiment, the graphene capsule is formed through depositing graphene on the silica cladding through a Chemical Vapor Deposition (CVD) process. The graphene capsule may functions as a cladding layer around the silica optic fiber in the absence of a silica cladding layer due to the difference in indices of reflection of silica and graphene. The graphene capsule may be formed of multiple layers of graphene. Alternatively, the graphene capsule may be formed of a single layer of graphene. Alternatively, the optic fiber is formed of halide-chalcogenide glass. The graphene capsule may be formed over the optic fiber made of halide-chalcogenide glass by a microwave plasma CVD system.

A graphene coated optic-fiber is disclosed that includes an optic-fiber having an end portion including an end surface and a length of the optic-fiber near the end surface. This optic fiber also includes a graphene end-cap covering the end portion of the optic fiber. This graphene end cap includes a tubular section of graphene surrounding an end portion of said optic-fiber and an end surface portion of graphene that seals off an end of said tubular section of graphene, thereby forming a contiguous cap. The tubular section of graphene is bonded to the end portion of graphene by carbon-carbon bonds. The optic fiber may be made of silica. Further the graphene end cap may be formed through a Chemical Vapor Deposition (CVD) process on the silica.

Further aspects of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings, wherein:

FIG. 1 illustrates an isometric view of a conventional prior art fiber optic cable;

FIG. 2 illustrates an end view of an undamaged conventional prior art optic fiber surrounded by cladding;

FIG. 3 illustrates the transmission of light between two joined conventional fiber optic cables that have undamaged surfaces;

FIG. 4 illustrates an end view of a damaged conventional optic fiber;

FIG. 5 illustrates the transmission of light between two joined conventional fiber optic cables that have damaged surfaces;

FIG. 6 illustrates a graphene sheet;

FIG. 7 illustrates an isometric view of a fiber optic cable connector having a graphene sheet covering an end of the fiber optic cable;

FIG. 8 illustrates a sectional view of an end of a fiber optic cable having a graphene sheet covering an optic fiber;

FIG. 9 illustrates a flow chart depicting a process for securing a graphene sheet to a fiber optic cable for wear protection;

FIG. 10 illustrates a flow diagram depicting an exemplary process for securing a graphene sheet to a fiber optic cable for wear protection;

FIG. 11 illustrates an isometric view of a fiber optic cable in which an optic fiber and cladding are contained within a nanotube;

FIG. 12 illustrates an isometric view of an optic fiber surrounded by cladding and contained within a nanotube having an end covered with a graphene layer;

FIG. 13 illustrates a flow chart depicting an exemplary process for securing a graphene sheet to a fiber optic cable that is formed of an optic fiber surrounded by cladding contained within a carbon nanotube;

FIG. 14 illustrates an isometric view of an alternative fiber optic cable in which an optic fiber is contained within a nanotube with cladding surrounding the nanotube;

FIG. 15 illustrates an isometric view of an optic fiber contained within a carbon nanotube having an end covered with a graphene layer; and

FIG. 16 illustrates a flow chart depicting an exemplary process for securing a graphene sheet to a fiber optic cable that is formed of an optic fiber contained within a carbon nanotube.

FIG. 17 illustrates an optic fiber encapsulated by a graphene capsule;

FIG. 18 illustrates the wavelength dependence of the index of refraction n for graphene;

FIGS. 19-22 diagrammatically depict a process for encapsulating a silica optic fiber with a graphene capsule through a Chemical Vapor Deposition (CVD) process;

FIG. 19 illustrates a silica optic fiber;

FIG. 20 illustrates a silica optic fiber coated with a sacrificial layer of copper;

FIG. 21 illustrates Chemical Vapor Deposition (CVD) of graphene on a silica optic fiber covered with a sacrificial layer of copper that de-wets during the CVD process;

FIG. 22 illustrates a silica optic fiber encapsulated within a graphene capsule;

FIG. 23 depicts a flow chart illustrating a process for encapsulating a silica optic fiber with a graphene capsule through a Chemical Vapor Deposition (CVD) process;

FIG. 24 illustrates a silica optic fiber surrounded by silica cladding and encapsulated by a graphene capsule;

FIG. 25-28 diagrammatically depict a process for encapsulating a silica optic fiber surrounded by silica cladding with a graphene capsule through a Chemical Vapor Deposition (CVD) process;

FIG. 25 illustrates a silica optic fiber surrounded by silica cladding;

FIG. 26 illustrates a silica optic fiber surrounded by silica cladding coated with a sacrificial layer of copper;

FIG. 27 illustrates Chemical Vapor Deposition (CVD) of graphene on the silica cladding covered with a sacrificial layer of copper that de-wets during the CVD process;

FIG. 28 illustrates a silica optic fiber surrounded by silica cladding encapsulated within a graphene capsule;

FIG. 29 depicts a flow chart illustrating a process for encapsulating a silica optic fiber surrounded by silica cladding with a graphene tube through a Chemical Vapor Deposition (CVD) process;

FIG. 30 illustrates a silica optic fiber surrounded by silica cladding having an end portion covered by a graphene cap; and

FIG. 31 illustrates an opto-electronic circuit utilizing a graphene coated optic fiber.

### DETAILED DESCRIPTION

While the invention has been shown and described with reference to a particular embodiment thereof, it will be understood to those skilled in the art, that various changes in form and details may be made therein without departing from the spirit and scope of the invention.

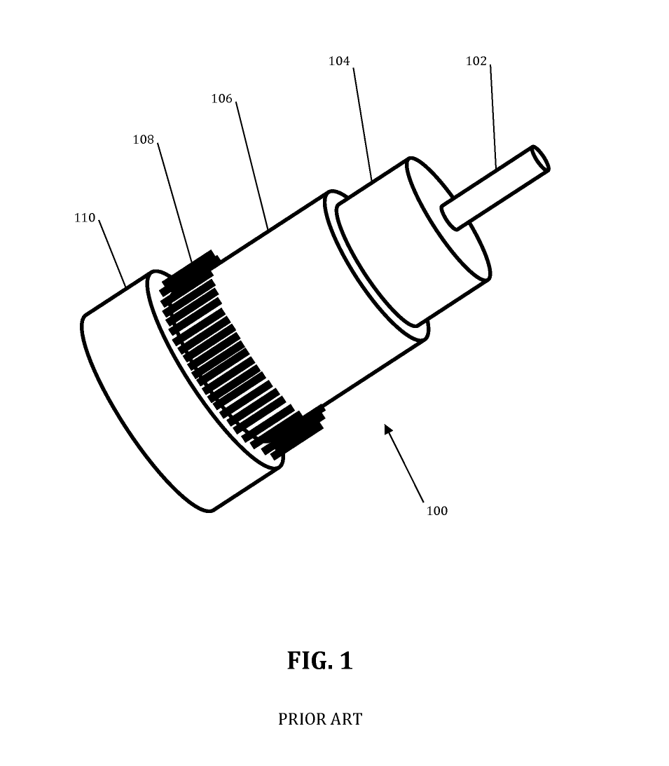

FIG. 1 illustrates an isometric view of a conventional PRIOR ART fiber optic cable 100. Fiber optic cable 100 includes an optical fiber core 102, herein referred to as an optic fiber. Cable 100 also includes cladding 104 that concentrically surrounds optical fiber 102. An insulating jacket 106 concentrically surrounds cladding 104. Strengthening fibers 108 are provided to add mechanical strength to cable 100. A jacket cover 110 is then provided to enclose strengthening fibers 108 within cable 100.

Optic fiber 102 is the physical medium that transports optical data signals from an attached light source at one end of cable 100, such as a SFP, small form-factor pluggable, (not shown) to a receiving device on the other end, which is typically another SFP (not shown). Optic fiber 102 is a single continuous strand of glass or plastic that is measured (in microns) by the size of its outer diameter. Cladding 104 is a thin layer that surrounds the optic fiber 102 and the core-cladding boundary contains the light waves within the optic fiber by causing the high-angle light-containing reflection, enabling data to travel throughout the length of optic fiber 102. Typically, optic fiber 102 and cladding 104 are made of high-purity silica glass. The light signals remain within optical fiber 102 due to total or near-total internal reflection at the core-cladding boundary, which is caused by the difference in the refractive index between cladding 104 and optic fiber 102.

Cladding 104 is typically coated with a layer of acrylate polymer or polymide, thereby forming an insulating jacket 106. Insulating jacket 106 protects optic fiber 102 from damage. Coating 106 also reinforces optic fiber 102, absorbs mechanical shocks, and provides extra protection against excessive cable bends.

Strengthening fibers 108 are provided to add mechanical strength to cable 100. Typically, strengthening fibers are made of KEVLART™, which is a para-aramid synthetic fiber and has the chemical name of poly-paraphenylene terephthalamide. A similar fiber called Twaron or nanotubes could be used as strengthening fibers 108. An outer jacket 110 is then provided to enclose cable 100 and protect optic fiber 102, cladding 104, insulating jacket 106, and strengthening fibers 108.

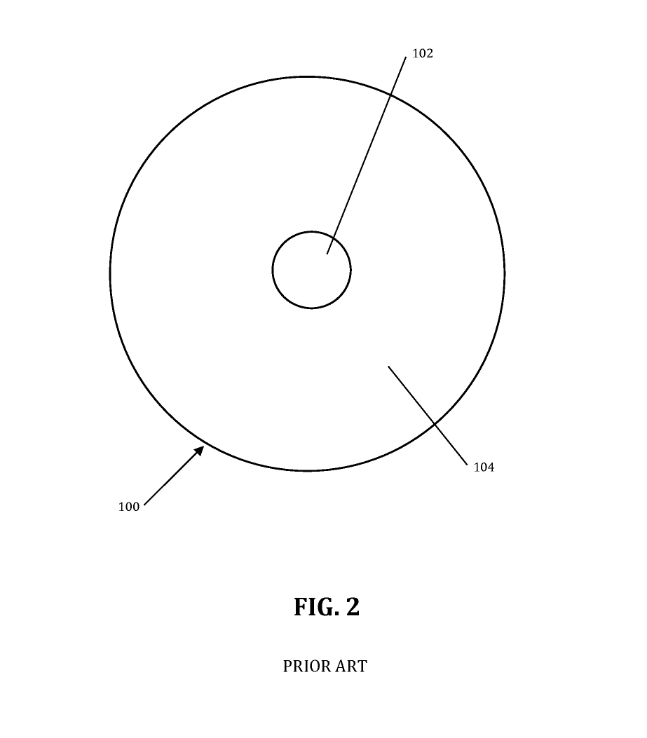

FIG. 2 illustrates an end view of an undamaged conventional PRIOR ART optic fiber 102 surrounded by cladding 104 of a fiber optic cable 100. This figure illustrates a “clean” end of a fiber optic cable that is not damaged. As such, cable 100 is capable of transmitting a clear signal to an adjoining cable that is similarly clean and not damaged.

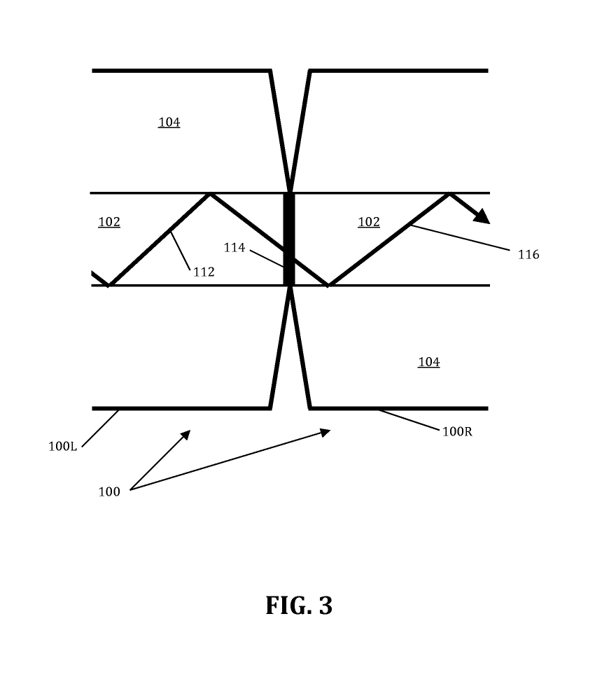

FIG. 3 illustrates the transmission of light between two joined conventional fiber optic cables 100 that have undamaged end-surfaces 114. Fiber optic cables 100 include optic fiber core 102 and cladding 104. An optical signal 112 propagates through core 102 from the cable 100 on the left 100L across core end-surfaces 114 into the cable 100 on the right 100R where it is shown as optical signal 116. When the core end-surfaces 114 of the two optical cables 100 are clean and free of damage, optical signal 112 is transmitted clearly and without distortion or loss of signal amplitude or such that optical signal 116 has the same strength of signal as optical signal 112.

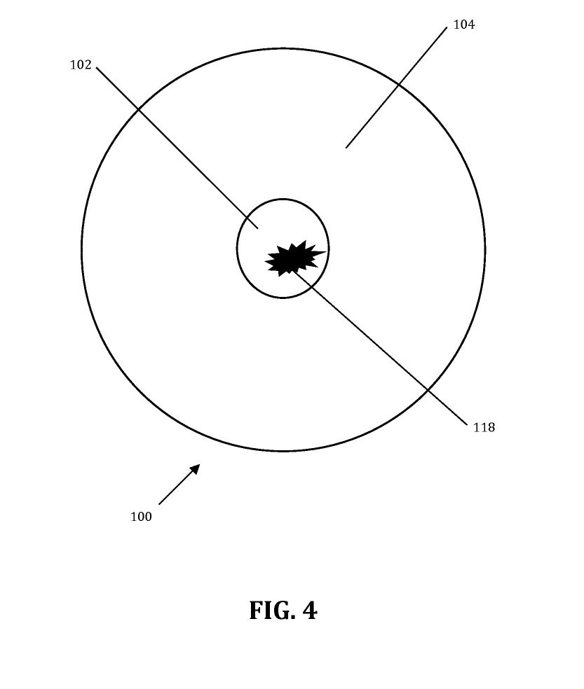

FIG. 4 illustrates an end view of a damaged conventional optic fiber cable 100. In this figure, fiber optic cable 100, which includes core 102 and cladding 104, has damage 118 to the end-surface of core 102. Damage 118 is surface damage to the end of core 102 such as a scratch, dent, chip, or other surface damage. Damage 118 negatively impacts the transmission of light signals by cable 100. Damage 118 and prevent the propagation of light signals from the source of the signal to the receiver. In addition, damage 118 can cause the light signals to reflect and bounce back to the source of the signal.

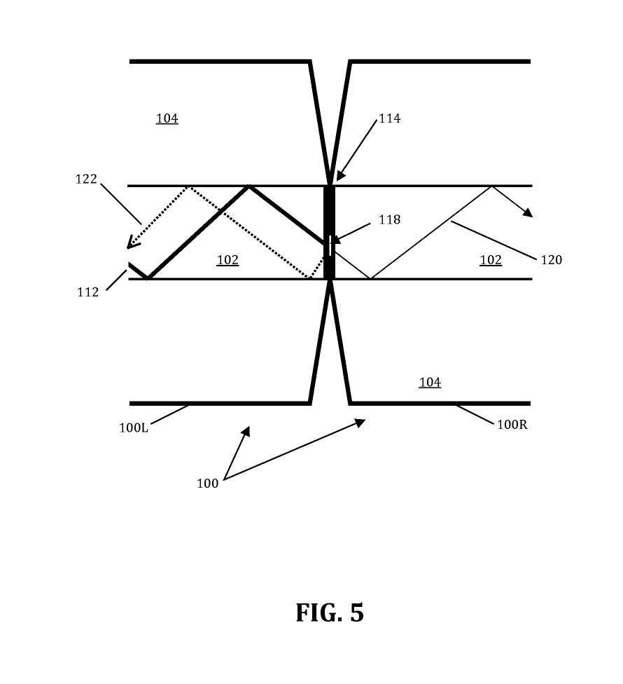

FIG. 5 illustrates the transmission of light between two joined conventional fiber optic cables 100 that have damage 118 to one or both core end-surfaces 114. Conventional fiber optic cables 100 include cores 102 and cladding 104. A light signal 112 is transmitted through cable 100 on the left 100L. Light signal 112 reaches the core end-surface 114 where it interacts with damage 118. Damage 118 can degrade the strength of signal 112, causing a weakened signal 120, a signal of lower amplitude than signal 116 of FIG. 3, to continue to propagate in cable 100 on the right 100R. Damage 118 can also cause some or all of signal 112 to be reflected back to the signal source as signal 122. As such, it is highly desirable to provide protection to the end-surfaces 114 of cores 102 of cables 100 to prevent signal-reducing damage to the core end-surfaces 114 of cables 100 in order to prevent unwanted reflective signals 122 and signals of reduced strength 120 as signal 112 crosses the junction between cores 102 of cables 100.

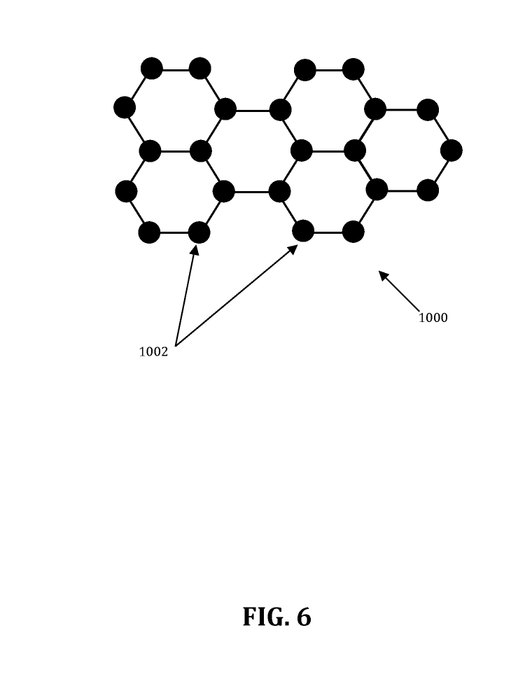

FIG. 6 illustrates a graphene sheet 1000. Graphene sheet 1000, also referred to as a graphene lattice 1000, is a flat monolayer of carbon atoms 1002 that are tightly packed into a two-dimensional lattice, thereby forming a sheet of graphene. Graphene lattice 1000 is 97.7% optically transparent. Thus, light used in combination with fiber optic cables can pass through a graphene layer for purposes of data transmission within a fiber optic communications network. Graphene lattice 1000 is an extremely strong material due to the covalent carbon-carbon bonds. It is desirable to utilize graphene lattices 1000 that are defect free as the presence of defects reduces the strength of graphene lattice 1000. The intrinsic strength of a defect free sheet of graphene 100 is 42 Nm⁻¹, making it one of the strongest materials known. The strength of graphene is comparable to the hardness of diamonds. Graphene is also a highly flexible material.

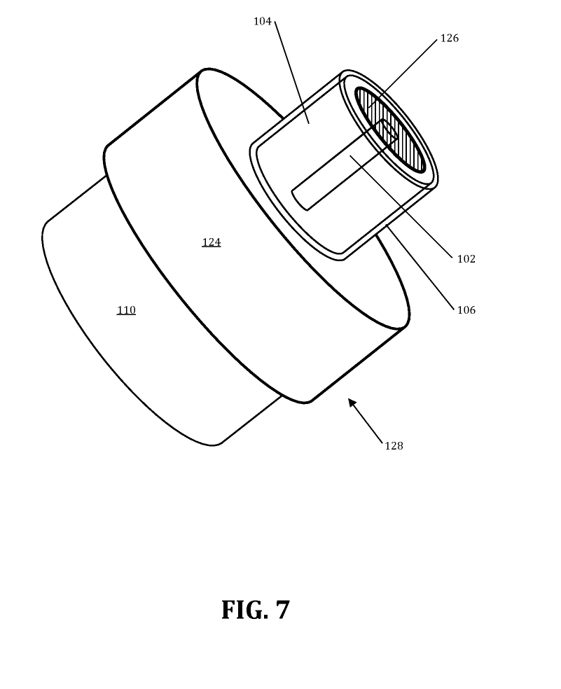

FIG. 7 illustrates an isometric view of a fiber optic cable connector 124 having a graphene sheet 126 covering an end of the fiber optic cable 128. A mechanical connector 124 is secured to the end of cable 128 in order to secure it to another fiber optic connector to connect it to a fiber optical communications network or a SFP device. Outer jacket 110 of cable 128 is shown leading into connector 124. While shown as a cylinder, connector 124 is typically a plastic or metal component configured to mate with another connector component to form a mechanical connection to hold cable 128 in position to allow for the transmission of light signals from core 102 into an adjoining core of another fiber optic cable. Core 102, cladding 104, and insulating jacket 106 are shown extending from connector 124 in order to form a fiber optic connection with an adjoining fiber optic cable.

In order to protect core 102 and cladding 104 from damage from abrasion or other mechanical damage, graphene layer 126 is attached to the end of cable 128. Graphene layer 126 is a contiguous sheet of graphene in that it is made of a single contiguous lattice of carbon atoms. Graphene layer 126 has a uniform thickness, such as a monolayer, a bilayer, or a trilayer. Graphene sheet 126, due to its high mechanical strength, functions as a wear protection layer for cable 128, core 102 and cladding 104. Graphene layer 126 is attached to fiber optic cable 128 such that a longitudinal axis of optic fiber core 102 is perpendicularly oriented to a plane formed by the contiguous sheet of graphene 126. It is desirable to utilize a single continguous sheet of graphene as a wear protection layer in order to maximize the mechanical strength of the graphene layer 126 to resist wear and damage. A non-contiguous sheet of graphene would not provide as much wear protection as a contiguous sheet. Further, a single contiguous sheet of graphene 126 that is of uniform thickness has uniform light transmission properties optimizing it for transmission of fiber optic signals. A non-contiguous sheet of non-uniform thickness would scatter light and degrade the strength of the fiber optic signal.

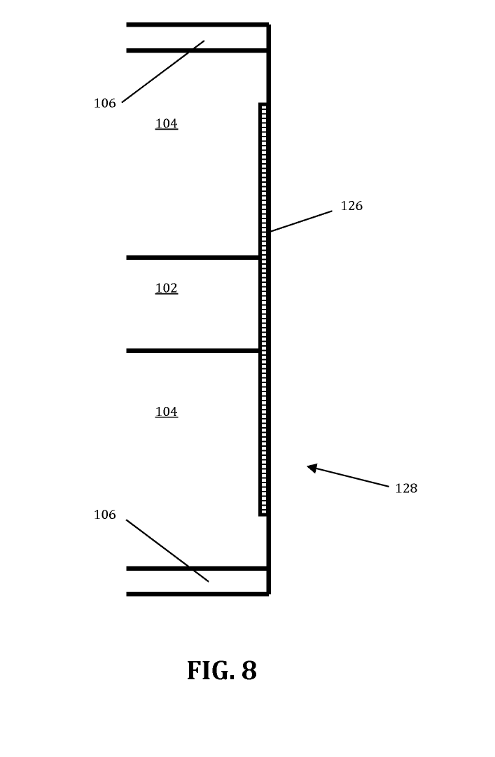

FIG. 8 illustrates a sectional view of an end of a fiber optic cable 128 having a graphene sheet 126 covering a fiber optic core 102. Fiber optic cable 128 includes a core 102, cladding 104 and insulating coating 106. Graphene layer 126 is attached to fiber optic cable 128 such that a longitudinal axis of optic fiber core 102 is perpendicularly oriented to a plane formed by the contiguous sheet of graphene 126. Graphene sheet 126 may be secured to cable core 102 and cladding 104 by a variety of methods. Graphene sheet 126 may be attached with an adhesive. Exemplary adhesives for graphene sheet 126 include, but are not limited to, cyanoacrylates, such as methyl-2-cyanoacrylate and ethyl-2-cyanoacrylate. Any adhesive capable of bonding a graphene sheet 102 to core 102 and cladding 104 is contemplated. Alternatively, the end-surface 114 of core 102 and/or cladding 104 may be flash heated with a laser. This flash heating softens the end-surface 114 of core 102 and cladding 104 sufficiently to enable graphene 126 to be embedded in the end-surface of core 102 and cladding 104. Also alternatively, a solvent may be used to soften the end-surfaces of core 102 and cladding 104 sufficient to enable graphene 126 to be embedded in the end-surface of core 102 and cladding 104. The use of flash heating is preferred for cables that have core 102 and cladding 104 made of silica. The use of solvents is preferred for cables that have core 102 and cladding 104 made of a polymer. As shown, graphene layer 126 has a uniform thickness and is contiguous. Graphene layer 126 allows the cleaning of end-surfaces 114 to remove light-blocking debris, and to protect end-surfaces 114 from scratches, pits, and other light degrading defects. Alternatively, graphene layer 126 may deposited on the end-surface through a Chemical Vapor Deposition (CVD) process.

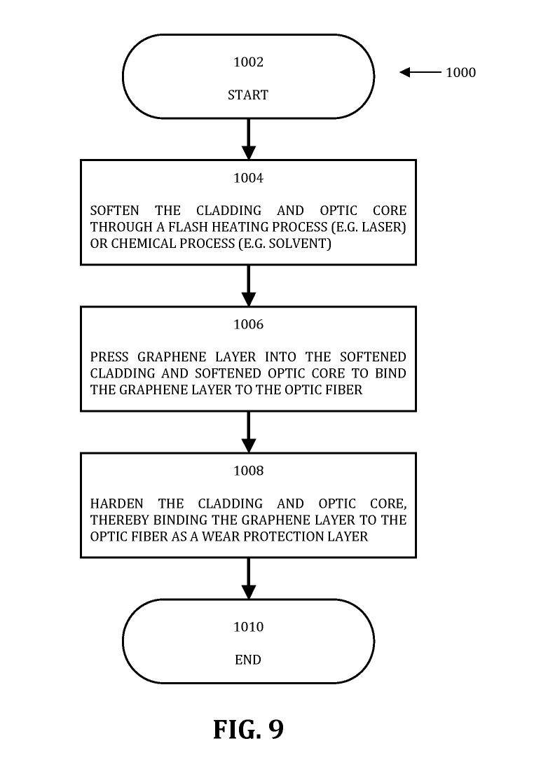

FIG. 9 illustrates a flow chart 1000 depicting a process for securing a graphene sheet to a fiber optic cable for wear protection. The process begins with START in step 1002. In step 1004, the cladding and/or core end-surface of a fiber optic cable is softened through a flash heating process with a laser or a chemical process with a solvent. In step 1006, a graphene layer is pressed into the softened cladding and/or optic core to bind the graphane layer to the optic fiber cable. In step 1008, the cladding and/or optic core are hardened, thereby binding the graphene layer to the optic fiber cable. As such, the graphene layer functions as a wear protection layer for the end of the optic fiber cable. The process ENDS in step 1010.

FIG. 10 illustrates a flow diagram depicting an exemplary process for securing a graphene sheet 126 to a fiber optic cable 128 for wear protection. At the top of the figure, an assembled fiber optic cable 128 with a fiber optic connector 124 is shown. The graphene sheet 126 is separate from fiber optic cable 128. A laser 130 shines a laser beam 132 onto the end-surface 114 of core 102 and cladding 104 to soften the end-surfaces by flash heating. Graphene layer 126 is then pressed into position on the end-surface of core 102 and cladding 104. The softened surfaces of core 102 and cladding 104 are then hardened, by cooling, binding graphene layer 126 to fiber optic cable 128 as shown in the bottom of the figure. In an alternate embodiment, strengthening fibers 108 are used to secure graphene layer 126.

While a exemplary connector 124 is shown, it is contemplated that any connector configuration may be used in combination with a graphene wear protection layer 126 embedded on the end of optic core 102 and cladding 104.

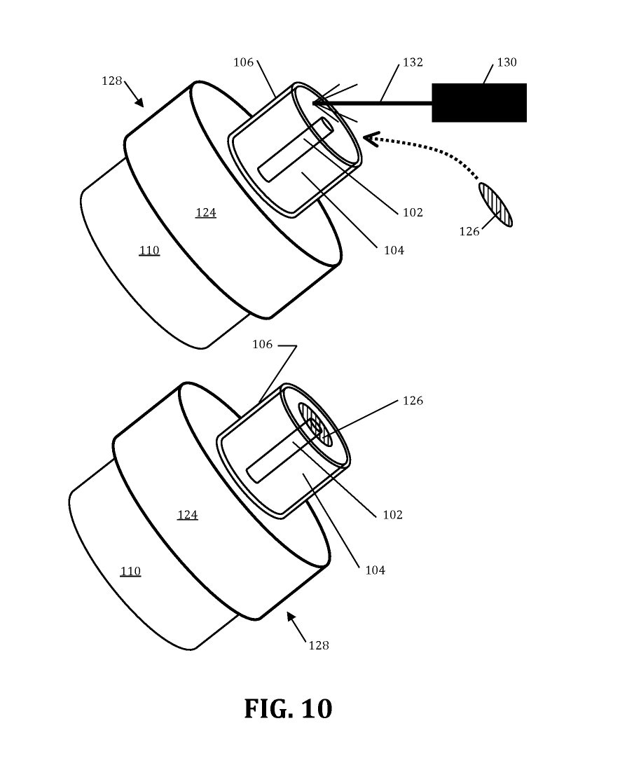

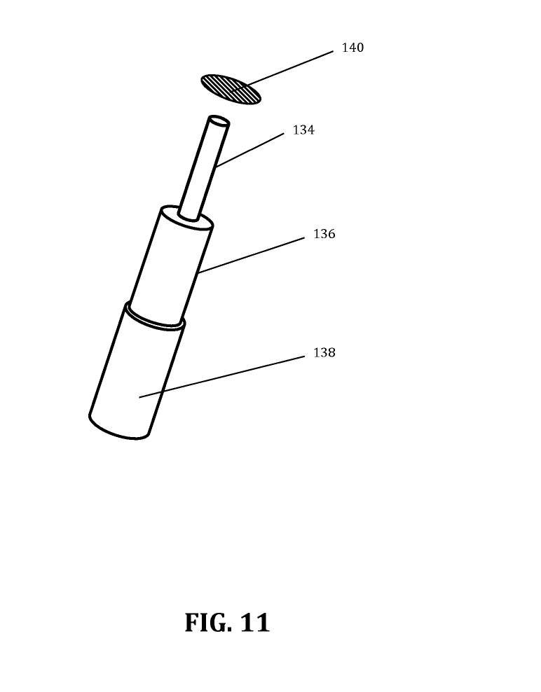

FIG. 11 illustrates an isometric view of a fiber optic cable in which an optic fiber 134 and cladding 136 are contained within a carbon nanotube 138. Optical fiber 134 may be formed of an optical nanofiber. For example, optic fiber 134 may be formed of a subwavelength-diameter optical fiber (SDF or SDOF). An SDF is an optical fiber whose diameter is less than the wavelength of the light being propagated through the fiber. Nanofibers 134 are extremely fragile. In order to provide strength to nanofiber 134, nanofiber 134 is contained within a nanotube 138 that provides mechanical strength. One type of nanotube 138 is a carbon nanotube. Nanofiber 134 is shown contained within cladding 136. Optic fiber 134 may be optionally contained within cladding 136 that is also contained within nanotube 138. Nanotube 138 may be formed of a carbon nanotube.

Alternatively, nanotube 138 could be formed of an inorganic nanotube. One type of inorganic nanotube is a metal oxide. Typical inorganic nanotube materials are 2D layered solids such as tungsten (IV) sulfide (WS₂), molybdenum disulfide (MoS₂) and tin (IV) sulfide (SnS₂). WS₂ and SnS₂/tin (II) sulfide (SnS) nanotubes have been synthesized in macroscopic amounts. However, traditional ceramics like titanium dioxide (TiO₂) and zinc oxide (ZnO) also form inorganic nanotubes. More recent nanotube materials are transition metal/chalcogen/halogenides (TMCH), described by the formula TM₆C_{y}H_{z}, where TM is transition metal (molybdenum, tungsten, tantalum, niobium), C is chalcogen (sulfur, selenium, tellurium), H is halogen (iodine), and the composition is given by 8.2<(y+z)<10. TMCH tubes can have a subnanometer-diameter, lengths tunable from hundreds of nanometers to tens of microns and show excellent dispersiveness owing to extremely weak mechanical coupling between the tubes. Inorganic nanotubes are morphologically similar to a carbon nanotube.

A graphene layer 140 is provided to serve as a cap to prevent damage to optic fiber 134. Graphene layer 140 may be bonded to fiber 134, and/or cladding 136, and/or nanotube 138. For example, when nanotube 138 is a carbon nanotube, cladding 140 can be bonded to nanotube 138 by placing graphene layer 140 on carbon nanotube 138 and exposing the assembly to a carbon atmosphere. Free carbon atoms will form carbon-carbon bonds between the graphene layer 140 and carbon nanotube 140, thereby bonding graphene layer 140 to nanotube 138. Alternatively, a flash heating process may be used to secure graphene layer 140 to fiber 134 and cladding 136. Also, adhesives can be used to secure graphene layer 140 to optic fiber 134, cladding 136, and/or nanotube 138.

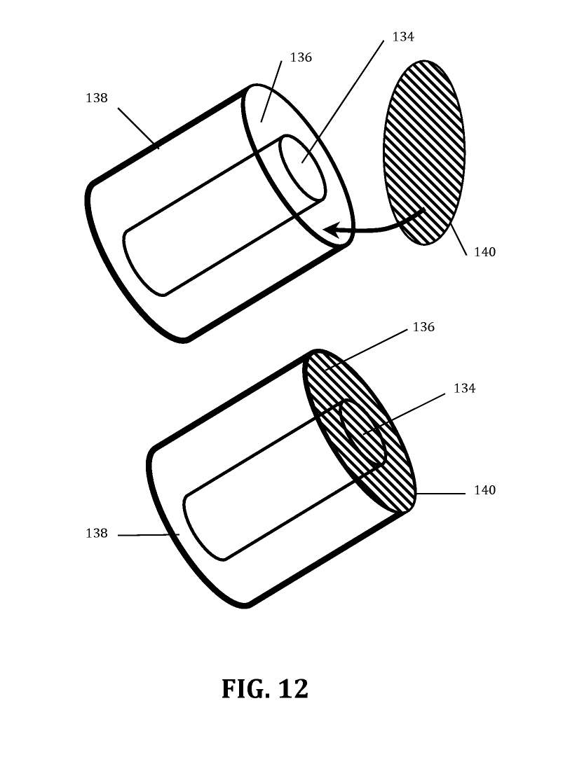

FIG. 12 illustrates an isometric view of an optic fiber 134 surrounded by cladding 136 and contained within a carbon nanotube 138 having an end covered with a graphene layer 140. At the top of FIG. 12, optic fiber 134 is contained within cladding 136 that is contained within a nanotube 138. Graphene layer 140 is shown separated in the top portion of the figure for illustrative purposes. In the bottom portion of FIG. 12, graphene layer 140 is shown secured to fiber 134, cladding 136, and/or nanotube 138. Graphene layer 140 and carbon nanotube 138 function in combination to provide mechanical support and protection to optic fiber 134. As graphene layer 140 is optically transparent, its placement does not inhibit the function of optic fiber 134.

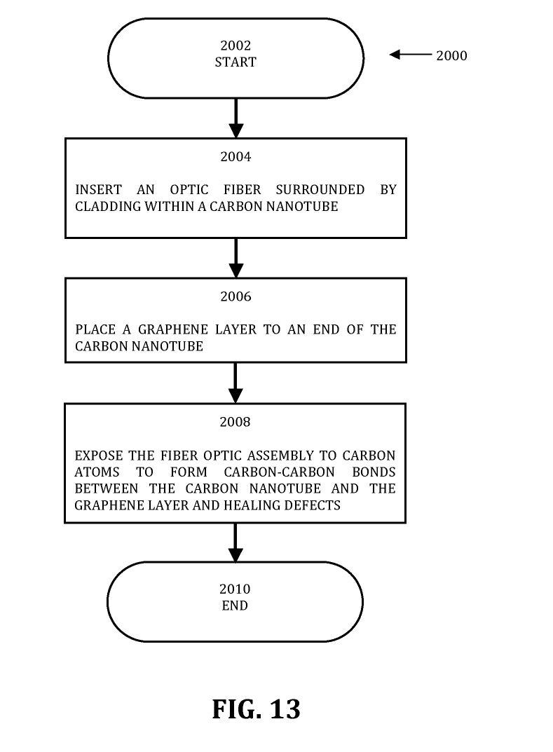

FIG. 13 illustrates a flow chart 2000 depicting an exemplary process for securing a graphene sheet 140 to a fiber optic cable that is formed of an optic fiber 134 surrounded by cladding 136 contained within a carbon nanotube 138. The process begins with START 2002. In step 2004, an optic fiber 134 surrounded by cladding 136 is inserted within a carbon nanotube. Alternatively, it is contemplated that other methods of placing an optic fiber within a carbon nanotube might be used, such as growing the nanotube around the optic fiber. In step 2006, a graphene layer 140 is placed on the end of the carbon nanotube 138. In step 2008, the assembly formed of the optic fiber 134, cladding 136, carbon nanotube 138 and graphene sheet 140 is exposed to free carbon atoms to form carbon-carbon bonds between the carbon nanotube 138 and the graphene layer 140 to bond the graphene layer 140 to the carbon nanotube 138. The process ENDS in step 2010. When graphene layer 140 is bonded to carbon nanotube 138, a contiguous end cap is formed protecting optic fiber 134.

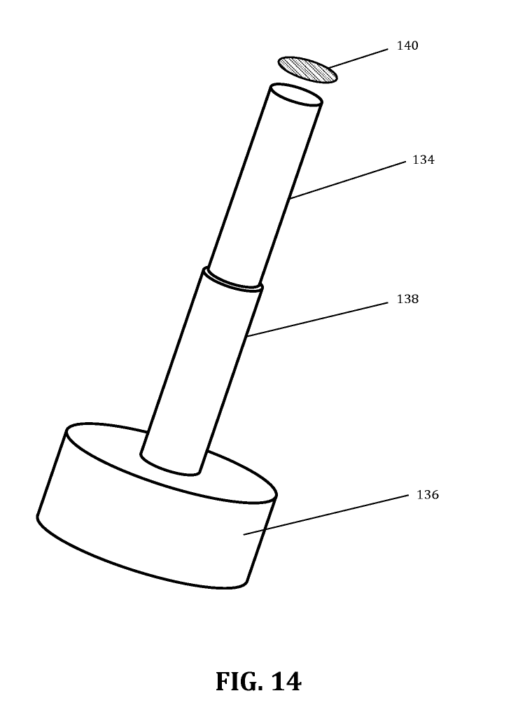

FIG. 14 illustrates an isometric view of an alternative fiber optic cable in which an optic fiber 134 is contained within a nanotube 138 where the cladding 136 is surrounding the nanotube 138. In this embodiment, cladding 136 is on the exterior of nanotube 138. There is no cladding 136 within nanotube 138. Nanotube 138 contained optic fiber 134 only. Graphene layer 140 is provided to cover the end of nanotube 138 in order to protect optic fiber 134. Note that the use of cladding 136 is optional. The fiber optic cable can be formed of a nanotube 138 and optic fiber 134 without the use of cladding 136. For example, interconnect for optical computers or optical processors could be formed of nanotubes 138 containing optic fibers 134.

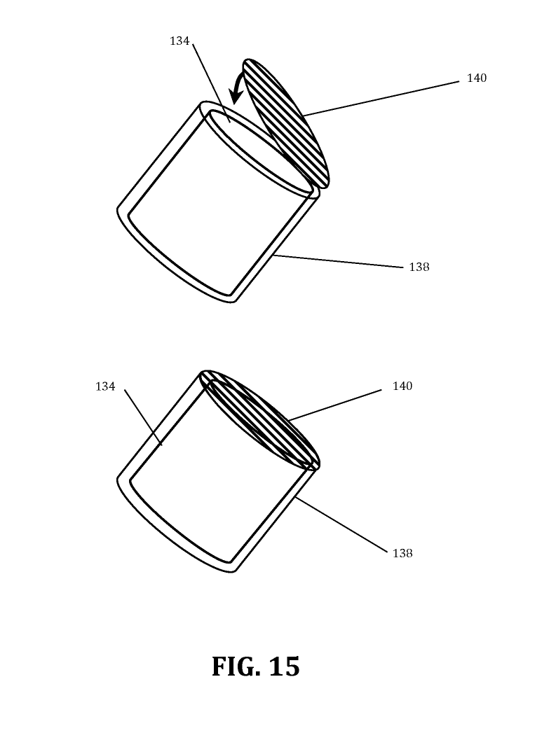

FIG. 15 illustrates an isometric view of an optic fiber 134 contained within a nanotube 138 having an end covered with a graphene layer 140. Nanotube 138 has a longitudinal axis that is aligned with a longitudinal axis of optic fiber 134. In FIG. 15, as optic fiber 134 is contained within nanotube 138, optic fiber 134 and nanotube 138 share the same longitudinal axis. Optic fiber 134 is longitudinally aligned with nanotube 138 within nanotube 138. Nanotube 138 provides mechanical support to optic fiber 134. Graphene layer 140 provides protection to optic fiber 134. Graphene layer 134 is bonded to nanotube 138. For example, exposure to free carbon atoms can form carbon-carbon bonds between graphene layer 134 and a carbon nanotube 138. Further, if there are any defects in carbon nanotube 138 or graphene layer 140, exposure to free carbon atoms, preferably in an oxygen-free atmosphere, can heal those defects through the free carbon atoms bonding to the defect sites in the carbon nanotube 138 or graphene layer 140. When graphene layer 140 is bonded to carbon nanotube 138, a contiguous end cap is formed protecting optic fiber 134.

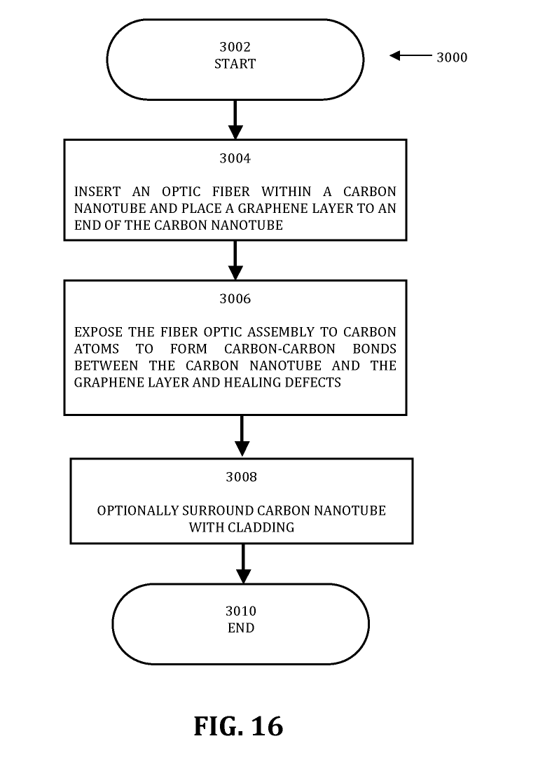

FIG. 16 illustrates a flow chart 3000 depicting an exemplary process for securing a graphene sheet 140 to a fiber optic cable that is formed of an optic fiber 134 contained within a carbon nanotube 138. The process begins with START 3002. In step 3004, an optic fiber 134 is inserted within a carbon nanotube 138 and a graphene layer 140 is placed on the end of carbon nanotube 138. In step 3006, the fiber optic assembly formed of the optic fiber 134, carbon nanotube 138 and graphene layer 140 is exposed to free carbon atoms, preferably in an oxygen-free atmosphere, so that carbon-carbon bonds will form between carbon nanotube 138 and graphene layer 140. In step 3008, carbon nanotube 138 may be optionally surrounded with cladding 136. The process ENDS in step 3010.

FIG. 17 illustrates an optic fiber 200 encapsulated by a graphene capsule 204. FIG. 17 includes a side view of optic fiber 200 encapsulated by a graphene capsule 204. FIG. 17 also includes a cross-sectional view “A” illustrating how graphene capsule 204 concentrically surrounds optic fiber 200. In this embodiment, graphene capsule 204 provides mechanical support to optic fiber 200. In addition, graphene capsule 204 functions as a cladding layer to optic fiber 200. Cladding 204 is one or more layers of materials of lower refractive index, in intimate contact with a core material 200 of higher refractive index. The cladding 204 causes light to be confined to the core of the fiber 200 by total internal reflection at the boundary between the two. Light propagation in the cladding 204 is suppressed in typical fiber. Some fibers can support cladding modes in which light propagates in the cladding 204 as well as the core 200.

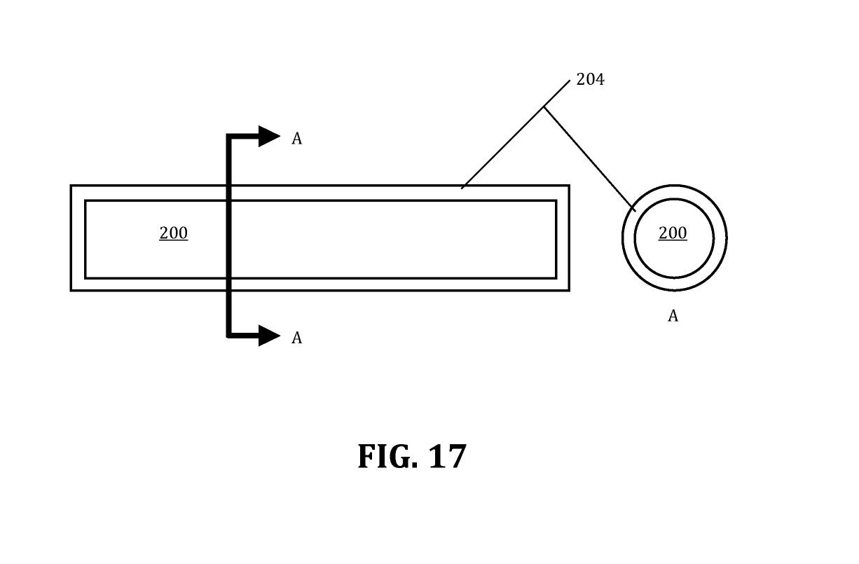

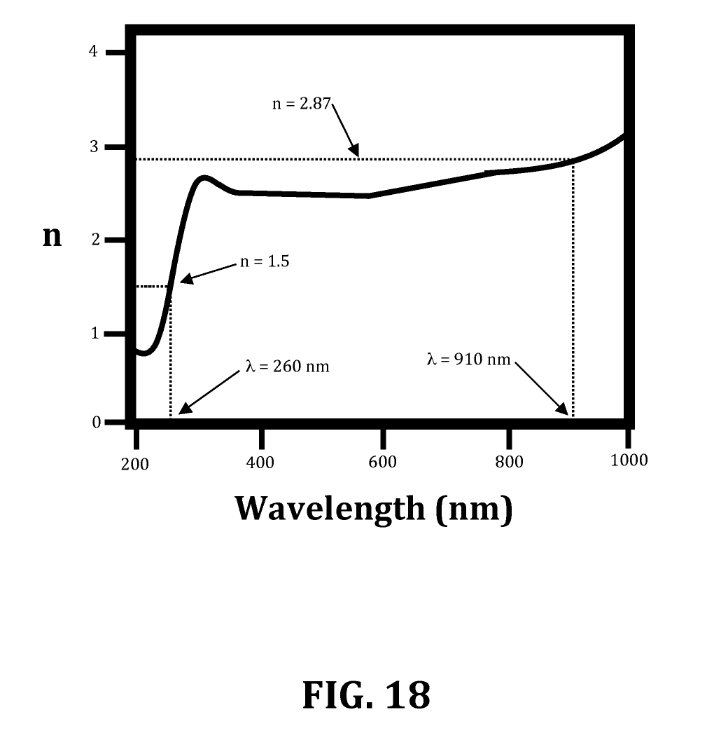

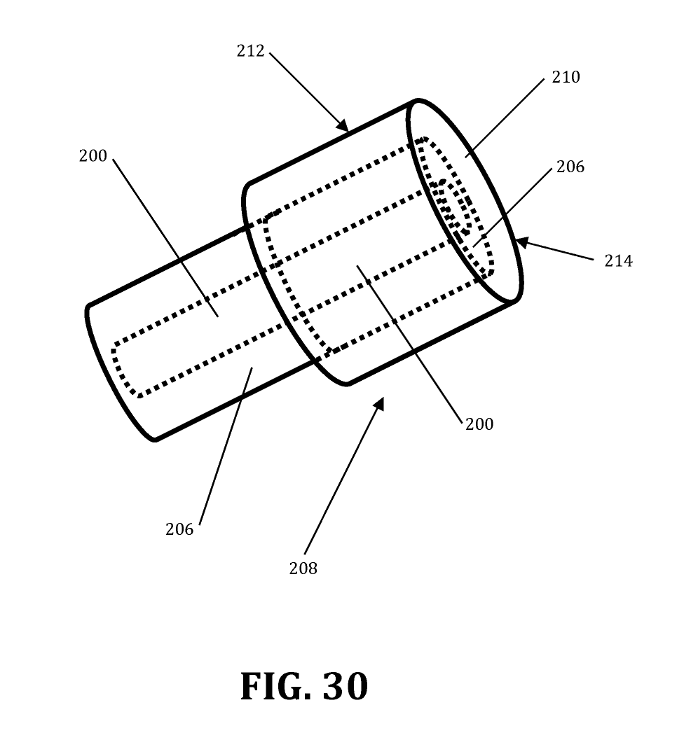

The index of refraction of graphene n is dependent upon the wavelength of light. FIG. 18 illustrates the wavelength dependence of the index of refraction n for graphene. Light having a wavelength from 200 nm to 400 nm is in the ultraviolet spectrum. Light having a wavelength in the range of 400 nm to 600 nm is in the violet-yellow spectrum. Light having a wavelength in the range of 600 nm to 800 nm is in the orange to red spectrum. Light having a wavelength in the range of 800 nm to 1000 nm is in the infrared spectrum. The wavelength dependence of the index of refraction n for graphene is reported in the following reference hereby incorporated by reference: Alex Gray, Mehdi Balooch, Stephane Allegret, Stefan De Gendt, and Wei-E Wang. Optical detection and characterization of graphene by broadband spectrophotometry. Journal of Applied Physics 104, 053109 (2008). As shown in FIG. 18, graphene has an index of refraction n<1 at 200 nm. Graphene exhibits an index of refraction n<1.5 below a wavelength of 260 nm. Silica is a common material for optic fibers 200. Silica has an index of refraction of n=1.5. Thus, when optic fiber 200 is made of silica and propagates light having a wavelength of less than 260 nm, graphene layer 204 can function as cladding because graphene layer 204 has a lower index of refraction than that of silica. An exemplary UV optic circuit utilizing a deep uv LED to emit deep UV light having a wavelength of 245 nm through an optic fiber 200 encapsulated in a graphene cladding layer 204 is shown in FIG. 30. At 245 nm, optic fiber 200 may be made of silica and encapsulated by a graphene layer 204 for cladding. Deep UV LEDs having a wavelength of 210 nm are also known and may be used in combination with optic fiber 200, allowing for smaller diameter sizes for optic fiber 200 with a silica core and graphene cladding 204.

Referring again to FIG. 18, graphene generally exhibits an index of refraction below 3 up to 900 nm. While optic fiber 200 is generally made of silica (SiO₂), other types of glasses may be used for optic fiber 200. In particular, a variety of high index of refraction glasses may be used for optic fiber 200. Through utilizing a glass with a higher index of refraction, it is possible to utilize a graphene layer 204 as a cladding layer at higher wavelengths of light. For example, halide-chalcogenide glasses have properties that make them suitable for optical fibers and they are reported to have indices of refraction n ranging from 2.54 to 2.87 as reported in the following reference hereby incorporated by reference: Jan Wasylak, Maria Lacka, Jan Kucharski. Glass of high refractive index for optics and optical fiber. Opt. Eng. 36(6) 1648-1651 (June 1997) Society of Photo-Optical Instrumentation Engineers. As illustrated in FIG. 18, when optic fiber 200 is made of a Halide-chalcogenide glass with an index of refraction of 2.87, graphene can be used as a cladding layer 204 for light of wavelengths of less than 910 nm, which is in the infrared portion of the spectrum. Thus, for the deep UV, visible, and a portion of the infrared spectrum Halide-chalcogenide glass may be used for optic fiber 200 and propagate light from 200 nm to 900 nm with a graphene cladding layer 204. The use of silica and halide-chalcogenide glasses are merely exemplary. It is contemplated that any glass may be utilized for optical fiber 200 in connection with a graphene cladding capsule 204 with the limitation that the propagation of light wavelengths is limited to the range such that the index of refraction of the graphene is less than the index of refraction of the particular glass used for optic fiber 200. Examples of other high index refraction glasses include PbO glass that has an index of refraction of n=2. Lanthanum dense flint glass has a refractive index of 1.8. Flint glass has a refractive index of 1.62.

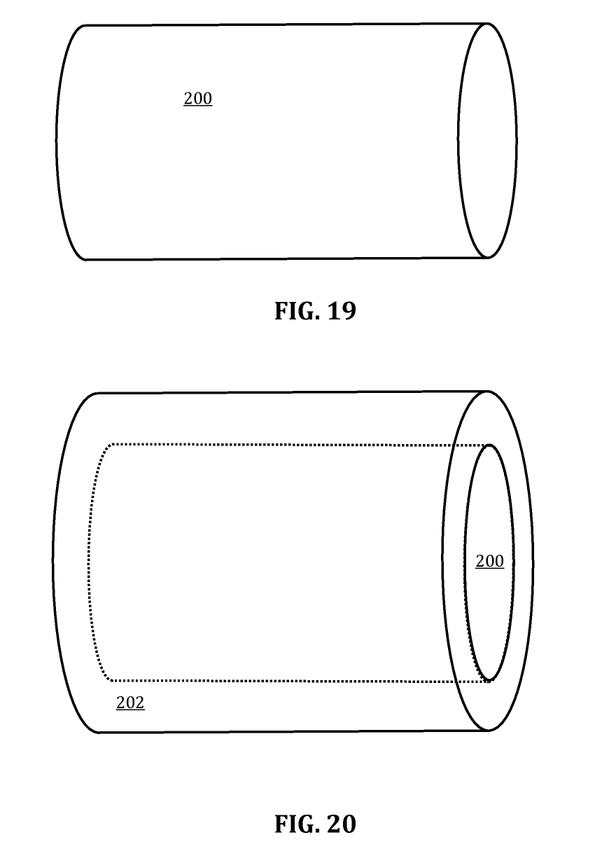

FIGS. 19-22 diagrammatically depict an exemplary process for encapsulating a silica optic fiber 200 within a graphene capsule 204 through a Chemical Vapor Deposition (CVD) process. FIG. 19 illustrates a silica optic fiber 200, where the process begins. Silica has a melting point of 1600° C. CVD deposition of graphene is a process that occurs at 1000° C. Thus, CVD deposition of graphene 204 occurs on silica fiber 200 without any morphological changes in silica fiber 200. While discussed with respect to silica, it is contemplated that the CVD deposition of graphene 204 may be performed on any optic glass with a sufficiently high melting point to permit CVD deposition of graphene without morphological changes in the optic fiber 200. To permit CVD growth of graphene on silica fiber 200, silica fiber 200 may be mounted to a substrate.

The next step depicted in FIG. 20 illustrates optic fiber 200 coated with a sacrificial layer of copper 202. Electron-beam evaporation is used to deposit copper (Cu) film 202 onto optic fiber 200. Copper film 200 functions as a sacrificial layer that de-wets and evaporates from silica fiber 200 during the CVD process.

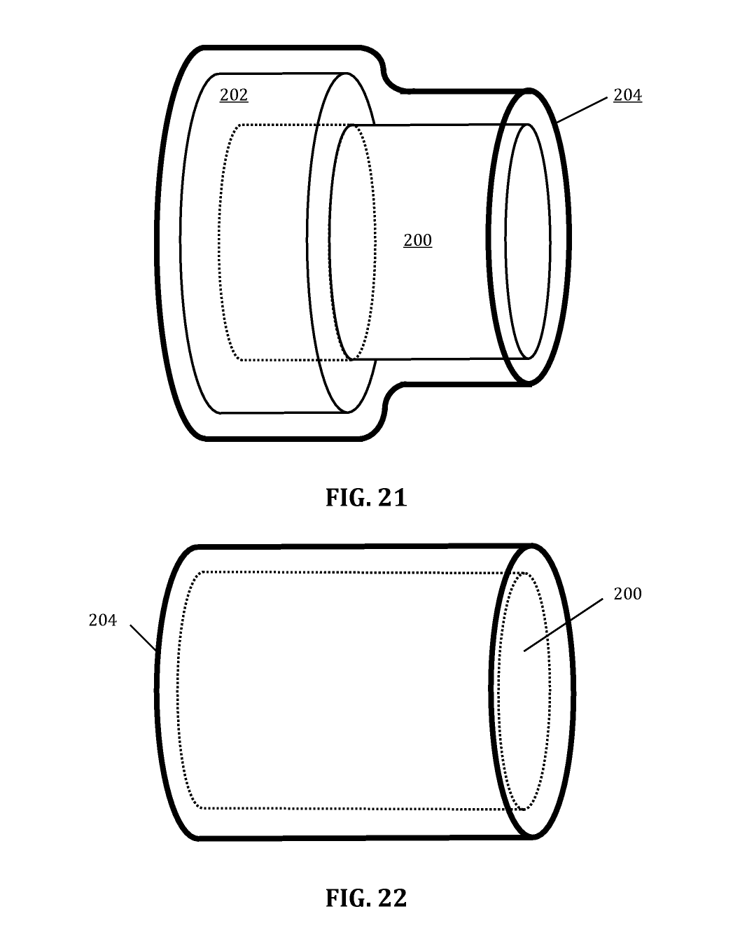

FIG. 21 illustrates Chemical Vapor Deposition (CVD) of graphene 204 on a silica optic fiber 200 covered with a sacrificial layer of copper 202 that de-wets during the CVD process. The copper 202 covered optic fibers 200 are placed within a CVD chamber and heated to 1000° C. CVD of graphene is performed on optic fibers 200 with durations varying from 15 min up to 7 h at 1000° C. Given the fact that that the melting temperature of the copper is ˜1084° C., along with the high temperature during the growth of ˜1000° C., and the low pressure in the chamber, 100-500 mTorr, copper layer 202 de-wets and evaporates during the CVD process. As such, copper layer 202 functions as a sacrificial layer. In FIG. 21, the deposition of graphene layer 204 is shown schematically as sacrificial copper layer 202 retreats and evaporates as it de-wets from optic fiber 200. The length of time of the CVD graphene deposition process varies the thickness of the graphene layer 204 from a monolayer to multiple layers of graphene. CVD growth of graphene directly on silica is described in the following reference, hereby incorporated by reference: Ariel Ismach, Clara Druzgalski, Samuel Penwell, Adam Schwartzberg, Maxwell Zheng, Ali Javey, Jeffrey Bokor, and Yuegang Zhang, Direct Chemical Vapor Deposition of Graphene on Dielectric Surfaces, Nano Lett. 2010, 10, 1542-1548, American Chemical Society, Apr. 2, 2010. In addition, growth of graphene on thin wires is described in the following publication, hereby incorporated by reference: Rui Wang, Yufeng Hao, Ziqian Wang, Mao Gong, and John T. L. Thong in Large-Diameter Graphene Nanotubes Synthesized Using Ni Nanowire Templates, Nano Lett. 2010, 10, 4844-4850, American Chemical Society, Oct. 28, 2010.

FIG. 22 illustrates a silica optic fiber 200 encapsulated within a graphene capsule 204. FIG. 22 illustrates the end result of the CVD graphene process. Silica optic fiber 200, represented by dashed lines, is shown encapsulated within graphene capsule 204. Silica optic fiber 200 may have a various diameters depending upon the wavelength of light it is configured to support. For example, for transmitting UV light with a wavelength of 200-400 nm, silica optic fiber may have a diameter larger than the 200-400 nm wavelength range of the light. For transmitting light having a wavelength in the range of 400-600 nm in the violet-yellow spectrum, silica optic fiber may have a diameter larger than 400-600 nm. For transmitting light having a wavelength in the range of 600-800 nm in the orange to red spectrum, silica optic fiber may have a diameter larger than 600-800 nm. For light having a wavelength in the range of 800-1000 nm in the infrared spectrum, silica optic fiber may have a diameter larger than 800-1000 nm. It is contemplated that the above discussed CVD process of graphene deposition may occur on conventional silica optic fibers having dimensions of 8-10 microns, 50-microns, 62.5-microns, and 100-microns. These diameter ranges are merely exemplary and are non-limiting.

Should silica optic fiber 200 have a diameter smaller than the wavelength of light it is transmitting, it is considered a subwavelength diameter fibers. So for example, if silica optic fiber had a diameter of 400 nm, it would be a subwavelength diameter fiber if it transmitted light of wavelength greater than 400 nm, but would not be considered a subwavelength diameter fiber if it transmitted light less than 400 nm in the deep UV. In the diameter range of 200-400 nm, silica optic fiber 200 may be considered an optic nanofiber.

One exemplary process for fabricating optic-nanofiber 200 is through tapering a commercial silica optical fiber. Special pulling machines accomplish the process. A bare silica fiber is fixed at two ends on the movable translation stages of the pulling machine. The middle of the fiber between the stages is then heated with a flame or a laser beam and at the same time the translation stages move in the opposite directions. The silica melts and the fiber is elongated so that its diameter decreases. The flame or laser beam usually also moves in order to obtain waist of significant length and constant thickness. Additional information regarding subwavelength and nanodiameter optic fibers is provided in the following publication, hereby incorporated by reference: Limin Tong and Michael Sumetsky. Subwavelength and Nanometer Diameter Optical Fibers. Springer; 2010 edition (Apr. 7, 2010). ISBN-13: 978-3642033612.

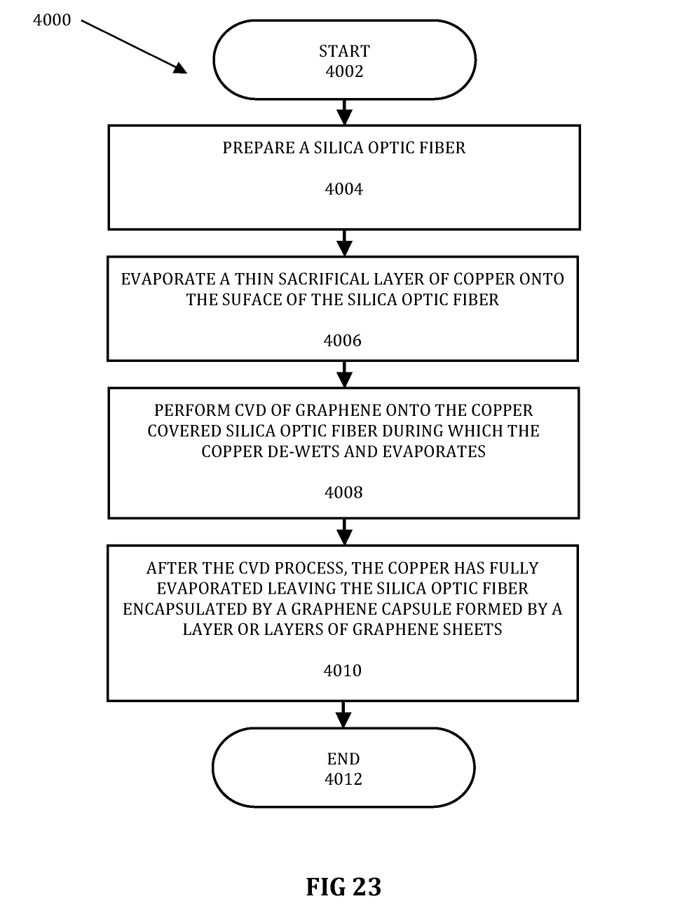

FIG. 23 depicts a flow chart illustrating a process for encapsulating silica optic fiber 200 with a graphene capsule 204 through a Chemical Vapor Deposition (CVD) process. It is desirable to provide mechanical support and protection to optic fiber 200 to ensure its proper function. To provide mechanical strength to optic fiber 200, a graphene capsule 204, shown in FIG. 22, is deposited on optic fiber 200 through an exemplary CVD process 4000 outlined in FIG. 23. The process begins with START in step 4002. In step 4004, a silica optic fiber 200, shown in FIG. 19 is prepared. Silica optic fiber 200 is utilized as a template upon which a graphene capsule 204 is grown by Chemical Vapor Deposition (CVD) onto silica optic fiber 200. CVD of graphene onto a tubular structure such as a nanowire or a silica optic fiber 200 produces a tubular graphene structure, more commonly known as a carbon nanotube, with end caps thereby forming a capsule.

In step 4006, a sacrifical copper film 202 is evaporated onto the silica optic fiber 200 as shown in FIG. 19. An electron-beam evaporation process is used to deposit the copper film onto the silica optic fiber.

In step 4008, silica optic fiber 200 having sacrifical copper layer 202 is inserted into a CVD chamber. Silica optic fiber 200 is heated to 1000° C. CVD of graphene is the performed on optic fibers 200 with durations varying from 15 min up to 7 h at 1000° C. Given the fact that that the melting temperature of the copper is ˜1084° C., along with the high temperature during the growth of ˜1000° C., and the low pressure in the chamber, 100-500 mTorr, copper film 202 de-wets and evaporates during the CVD process. Ethylene (C₂H₄) or CH₄ is introduced into the CVD chamber as the carbon containing precursor, in addition to the H₂/Ar flow. The precursor feeding time, typically in the order of a few to tens of seconds, determines the number of layers of graphene grown. The sample may then be cooled to room temperature within 5 min in a flow of 133 sccm Ar at 20 Torr chamber pressure. Silica optic fiber 200 is resilient to morphological changes at ˜1000° C. required for the CVD growth of high-quality graphene due to the high melting point of silica of 1600° C. During the CVD deposition process, sacrificial copper layer 202 de-wets and evaporates as shown schematically in FIG. 21. In FIG. 21, the graphene layer 204 is deposited onto silica optic fiber 200. During this CVD process, sacrificial copper layer 202 de-wets and evaporates exposing silica optic fiber 200 directly to graphene layer 204.

In step 4010, the CVD process is completed in which sacrificial copper layer 202 has fully evaporated leaving one or more layers of graphene deposited onto silica optic fiber 200. Utilization of silica optic fiber 200 results in the synthesis of graphene sheets on optic fiber 200. The number of graphene sheets is determined by the growth time and is independent of tube diameter and tube length. As a consequence of this process 4000, a silica optic fiber is encapsulted within a carbon nanotube 204 formed of a graphene layer or layers 204 with graphene end caps. Graphene capsule 204 provides mechanical strength to optic fiber 200. The process ends in step 4012. Processes for creating tubular graphene structures, also known as carbon nanotubes, have been demonstrated on 70 nm Nickel (Ni) nanowires as described in the following publication, hereby incorporated by reference: Rui Wang, Yufeng Hao, Ziqian Wang, Hao Gong, and John T. L. Thong in Large-Diameter Graphene Nanotubes Synthesized Using Ni Nanowire Templates, Nano Lett. 2010, 10, 4844-4850, American Chemical Society, Oct. 28, 2010. However, unlike the process disclosed by Wang utilizing a sacrificial Ni nanowire template, the present invention utilizes a silica optic-nanofiber core that is retained as an essential component of the optic fiber contained within a tubular graphene sheet, i.e. a carbon nanotube, capped at both ends to encapsulate optic fiber 200. Processes for direct chemical vapor deposition of graphene on dielectric surfaces such as silica are described in the following publication, hereby incorporated by reference: Ariel Ismach, Clara Druzgalski, Samuel Penwell, Adam Schwartzberg, Maxwell Zheng, Ali Javey, Jeffrey Bokor, and Yuegang Zhang, Direct Chemical Vapor Deposition of Graphene on Dielectric Surfaces, Nano Lett. 2010, 10, 1542-1548, American Chemical Society, Apr. 2, 2010.

The flow chart depicted in FIG. 23 is one exemplary method of CVD deposition of graphene on silica. Other methods of CVD deposition on silica are known and may be used to deposit a graphene capsule on an optic fiber 200. For example, graphene capsule 204 may be deposited directly on to optic fiber 200 without the use of a metal catalyst, such as sacrificial copper layer 202 described in FIG. 23. The CVD is performed in a atmospheric pressure hot-wall quartz tube furnace. CH₄ is used as a carbon precursor gas, mixed with auxiliary reduction (H₂) and carrier (Ar) gases. The optic fibers 200 are heated to 1000° C. (at a rate of 30° C./min) under H₂ (50 sccm) and Ar (1000 sccm) atmosphere and kept at 1000° C. for 3 min. Then, 300 sccm CH₄ is introduced to initiate the formation of graphene. The typical growth time is 30-60 min. After the deposition, the CH₄ flow is stopped, leaving other gases to flow for further 3 min to remove residual reaction gases before allowing the chamber to naturally cool to room temperature (20° C./min) in the same H₂—Ar atmosphere. The graphene layer 204 can also be deposited directly on SiO₂ by using other hydrocarbon precursors, such as C₂H₂, showing the generality of the process. The growth of graphene directly on a silica substrate is reported in the following publication, hereby incorporated by reference: Jie Sun , Niclas Lindvall, Matthew T. Cole, Teng Wang, Tim J. Booth, Peter Bøggild, Kenneth B. K. Teo, Johan Liu, and August Yurgens. Controllable chemical vapor deposition of large area uniform nanocrystalline graphene directly on silicon dioxide. Journal of Applied Physics 111, 044103 (2012).

The processes discussed above in FIG. 23 and in the paragraph above are not compatible with halide-chalcogenide glasses due to the high temperatures of the CVD process. Halide-chalcogenide glasses have a melting temperature of 378° C. and would not survive a CVD process at 1000° C. However, a variety of low-temperature graphene synthesis techniques are known with very low thermal budgets. With these technique, the halide-chalcogenide glasses are heated to temperatures around 300° C. for graphene growth. For example, a halide-chalcogenide optic fiber 200, shown in FIG. 19, may be heated in a CVD chamber to 300° C. and exposed to a benzene precursor as the carbon source to create a monolayer of graphene. This process is reported in the following publication, hereby incorporated by reference: Zhancheng Li, Ping Wu, Chenxi Wang, Xiaodong Fan, Wenhua Zhang, Xiaofang Zhai, Changgan Zeng, Zhenyu Li, Jinlong Yang, and Jianguo Hou. Low-Temperature Growth of Graphene by Chemical Vapor Deposition Using Solid and Liquid Carbon Sources. ACSNANO VOL. 5, NO. 4, 3385-3390, 2011. In an alternative low temperature process, graphene film may be synthesized on a halide-chalcogenide optic fiber 200 at 280° C. utilizing a microwave plasma treatment in combination with PolyMethylMethacrylate (PMMA). With this process, a layer of PMMA is spin-coated onto a halide-chalcogenide optic fiber 200 at room temperature. The PMMA coated halide-chalcogenide optic fiber 200 is then inserted into a slot antenna-type microwave plasma CVD system for microwave plasma treatment at 280° C. The plasma treatment time is 30 seconds. This plasma treatment process is disclosed in the following publication, hereby incorporated by reference: Takatoshi Yamada, Masatou Ishihara, and Masataka Hasegawa. Low Temperature Graphene Synthesis from Poly(methyl methacrylate) Using Microwave Plasma Treatment. Applied Physics Express 6 (2013) 115102-1.

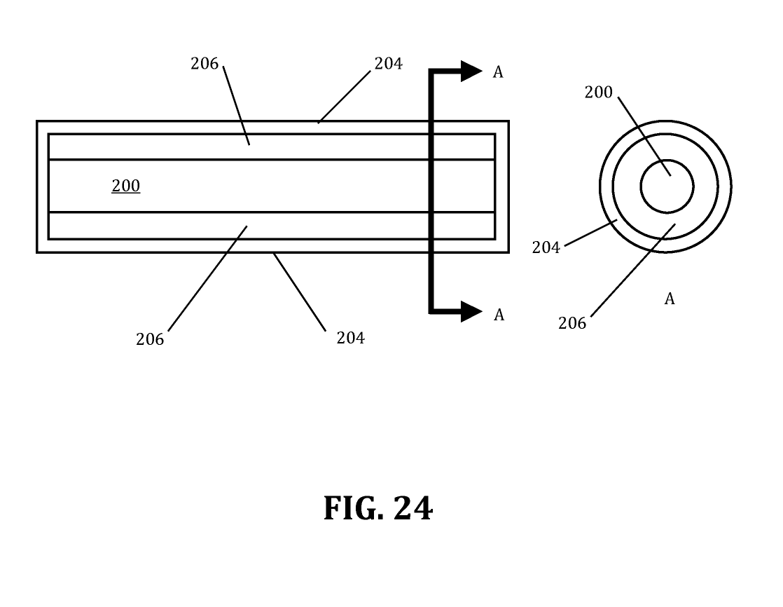

FIG. 24 illustrates an optic fiber 200 surrounded by cladding 206 and encapsulated by a graphene capsule 204. Graphene capsule 204 fully encapsulates optic fiber 200 and cladding 206. FIG. 24 illustrates a side cross section of optic fiber 200 surrounded by cladding 206 and encapsulated by graphene capsule 204. FIG. 24 also illustrates a cross section A of optic fiber 200 surrounded by cladding 206 and encapsulated by graphene 204. Cladding 206 is one or more layers of materials of lower refractive index, in intimate contact with a core material 200 of higher refractive index. The cladding 206 causes light to be confined to the core of the fiber 200 by total internal reflection at the boundary between the two. Light propagation in the cladding 206 is suppressed in typical fiber. Some fibers can support cladding modes in which light propagates in the cladding 206 as well as the core 200. In a preferred embodiment, optic fiber 200 is made of silica. In addition, cladding 206 may also be made of silica. When the optic fiber 200 and cladding 206 are both made of silica, the fiber may be referred to as an all-silica fiber.

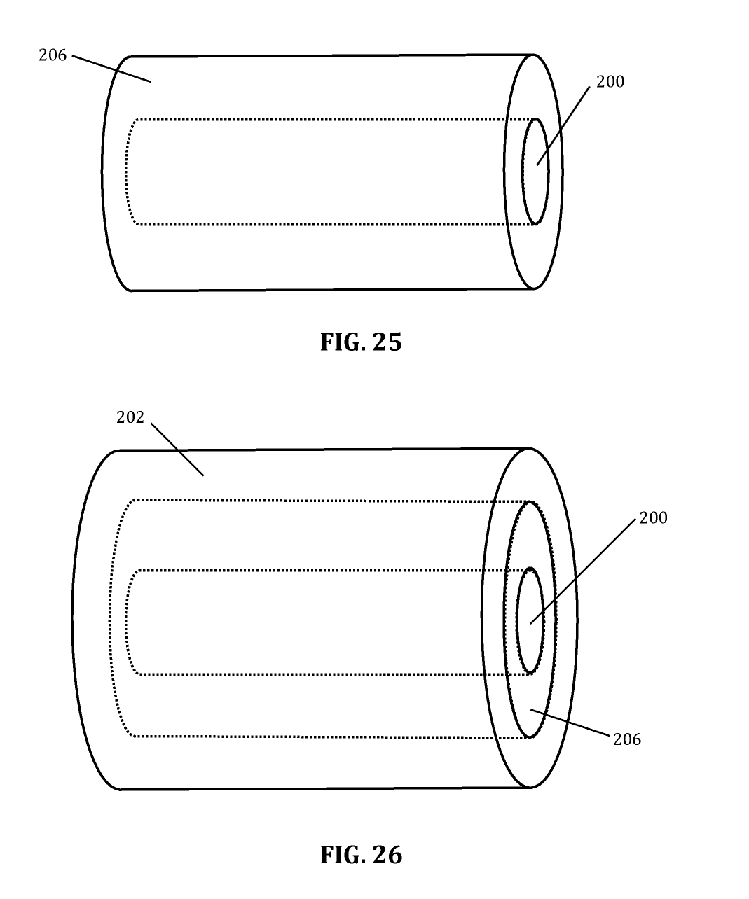

FIG. 25-28 diagrammatically depict a process for encapsulating a silica optic fiber 200 surrounded by silica cladding 206 with a graphene capsule 204 through a Chemical Vapor Deposition (CVD) process. FIG. 25 illustrates a silica optic fiber 200 surrounded by silica cladding 206 where the process begins. It is desirable to utilize silica as a material for the optic fiber 200 and cladding 206 due to the fact that silica has a melting temperature of 1600° C. CVD deposition of graphene is a process that occurs at 1000° C. Thus, CVD deposition of graphene 204 occurs on silica fiber 200 and cladding 206 without any morphological changes in silica fiber 200 or cladding 206. While discussed with respect to silica, it is contemplated that the CVD deposition of graphene 204 may be performed on any optic glass with a sufficiently high melting point to permit CVD deposition of graphene without morphological changes in the optic fiber 200 or cladding 206. To permit CVD growth of graphene on silica fiber 200 and cladding 206, silica fiber 200 and cladding 206 may be mounted to a substrate. This process may deposit a single layer of graphene to form graphene capsule 204. This process may also deposit multiple layers of graphene to form a multi-layered graphene capsule.

FIG. 26 illustrates an optic fiber 200 surrounded by silica cladding 206 coated with a sacrificial layer of copper 202. Electron-beam evaporation is used to deposit copper (Cu) film 202 onto optic fiber 200. Copper film 200 functions as a sacrificial layer that de-wets and evaporates from silica fiber 200 during the CVD process.

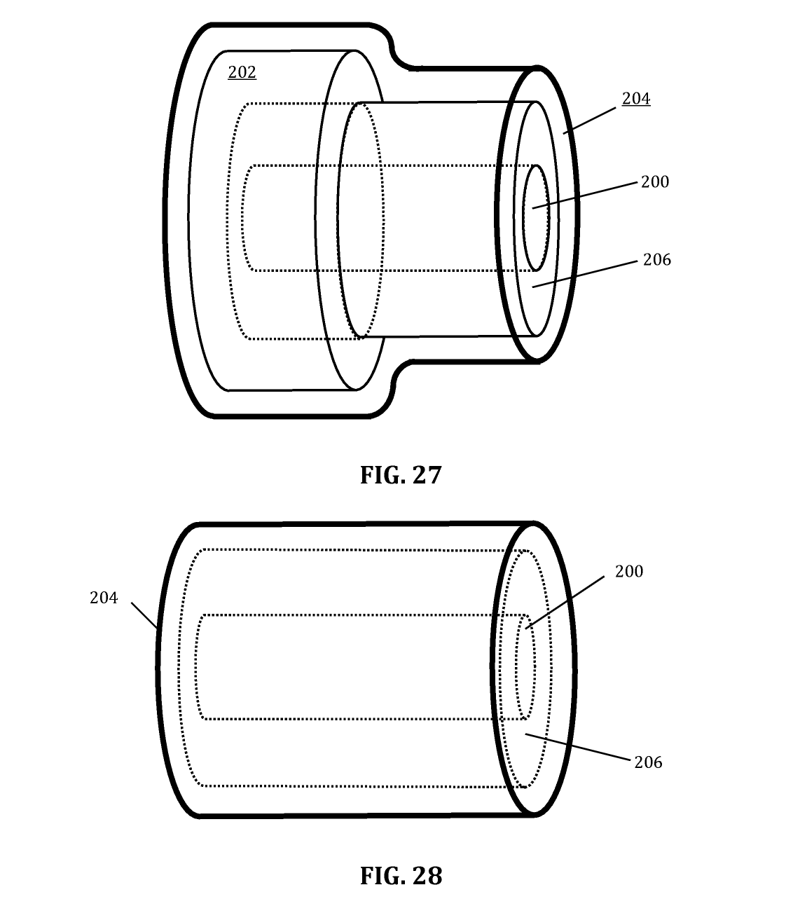

FIG. 27 illustrates Chemical Vapor Deposition (CVD) of graphene 204 on silica cladding 206 covered with a sacrificial layer of copper 202 that de-wets during the CVD process. The copper layer 202 covered cladding 206 is placed within a CVD chamber and heated to 1000° C. CVD of graphene is performed on cladding 206 with durations varying from 15 min up to 7 h at 1000° C. Given the fact that that the melting temperature of the copper is ˜1084° C., along with the high temperature during the growth of ˜1000° C., and the low pressure in the chamber, 100-500 mTorr, copper layer 202 de-wets and evaporates during the CVD process. As such, copper layer 202 functions as a sacrificial layer. In FIG. 27, the deposition of graphene layer 204 is shown schematically as sacrificial copper layer 202 retreats and evaporates as it de-wets from silica cladding 206. The length of time of the CVD graphene deposition process varies the thickness of the graphene layer 204 from a monolayer to multiple layers of graphene.

FIG. 28 illustrates a silica optic fiber 200 surrounded by silica cladding 206 encapsulated within a graphene capsule 204. Silica optic fiber 200 and silica cladding 206 are shown by dashed lines as they are encapsulated by graphene capsule 204. FIG. 28 illustrates the end result of the CVD graphene process. Silica optic fiber 200 may have a various diameters depending upon the wavelength of light it is configured to support. For example, for transmitting UV light with a wavelength of 200-400 nm, silica optic fiber may have a diameter larger than the 200-400 nm wavelength range of the light. For transmitting light having a wavelength in the range of 400-600 nm in the violet-yellow spectrum, silica optic fiber may have a diameter larger than 400-600 nm. For transmitting light having a wavelength in the range of 600-800 nm in the orange to red spectrum, silica optic fiber may have a diameter larger than 600-800 nm. For light having a wavelength in the range of 800-1000 nm in the infrared spectrum, silica optic fiber may have a diameter larger than 800-1000 nm. It is contemplated that the above discussed CVD process of graphene deposition may occur on conventional silica optic fibers having dimensions of 8-10 microns, 50-microns, 62.5-microns, and 100-microns. These diameters are merely exemplary and are non-limiting.

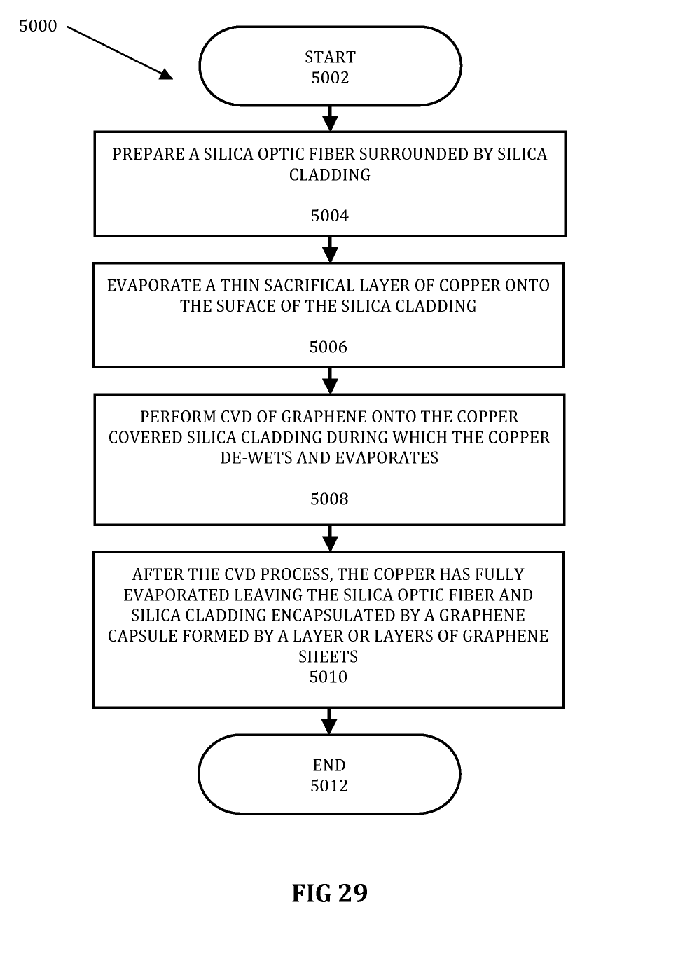

FIG. 29 depicts a flow chart illustrating a process for encapsulating a silica optic fiber 200 surrounded by silica cladding 206 with a graphene capsule 204 through a Chemical Vapor Deposition (CVD) process. It is desirable to provide mechanical support and protection to silica optic fiber 200 surrounded by silica cladding 206 to ensure its proper function. To provide mechanical strength to silica optic fiber 200 and silica cladding 206, a graphene capsule 204, shown in FIG. 28, is deposited on silica cladding 206 through an exemplary CVD process 5000 outlined in FIG. 29. The process begins with START in step 5002. In step 5004, a silica optic fiber 200 surrounded by cladding 206, shown in FIG. 25 is prepared. Silica optic fiber 200 with silica cladding 206 is utilized as a template upon which a graphene capsule is grown by Chemical Vapor Deposition (CVD) onto silica cladding 206. CVD of graphene onto a tubular structure such as a nanowire or a silica optic-nanofiber 200 produces a tubular graphene structure, more commonly known as a carbon nanotube.

In step 5006, a sacrifical copper film 202 is evaporated onto the silica cladding 206 as shown in FIG. 26. An electron-beam evaporation process is used to deposit the copper film onto the silica cladding 206.

In step 5008, silica cladding 206 having sacrifical copper layer 202 is inserted into a CVD chamber. Silica optic fiber 200 and silica cladding 206 are heated to 1000° C. CVD of graphene is the performed on optic fibers 200 and cladding 206 with durations varying from 15 min up to 7 h at 1000° C. Given the fact that that the melting temperature of the copper is ˜1084° C., along with the high temperature during the growth of ˜1000° C., and the low pressure in the chamber, 100-500 mTorr, copper film 202 de-wets and evaporates during the CVD process. Ethylene (C₂H₄) or CH₄ is introduced into the CVD chamber as the carbon containing precursor, in addition to the H₂/Ar flow. The precursor feeding time, typically in the order of a few to tens of seconds, determines the number of layers of graphene grown. The sample may then be cooled to room temperature within 5 min in a flow of 133 sccm Ar at 20 Torr chamber pressure. Silica optic fiber 200 is resilient to morphological changes at ˜1000° C. required for the CVD growth of high-quality graphene due to the high melting point of silica of 1600° C. During the CVD deposition process, sacrificial copper layer 202 de-wets and evaporates as shown schematically in FIG. 27. In FIG. 28, the graphene layer 204 is deposited onto silica cladding 206 surrounding silica optic fiber 200. During this CVD process, sacrificial copper layer 202 de-wets and evaporates exposing silica cladding 206 directly to graphene layer 204.

In step 5010, the CVD process is completed in which sacrificial copper layer 202 has fully evaporated leaving one or more layers of graphene deposited onto silica cladding 206. The number of graphene sheets is determined by the growth time and is independent of tube diameter and tube length. As a consequence of this process 5000, a silica optic fiber 200 surrounded by silica cladding is encapsulted within a graphene capsule 204 formed of a graphene layer or layers 204. Graphene capsule 204 provides mechanical strength to optic nanofiber 200. The process ends in step 5012.

FIG. 30 illustrates a perspective view of an optic fiber 200 surrounded by cladding 206 having an end cap portion 208 covered with a graphene cap 210 formed through CVD. In this embodiment, only an end portion 208 of optic fiber 200 and cladding 206 are coated in graphene. By coating an end portion 208 of optic fiber 200 and cladding 206 with graphene through CVD, it is possible provide protection and mechanical support to the end portion 208 of optic fiber 200 and cladding 206. The end portion of optic fiber 200 includes a length of the optic fiber near an end surface of the optic fiber. As such, graphene cap 210 includes a tubular portion of graphene 212 to cylindrically surround the length of the optic fiber near the end surface of optic fiber 200. Graphene cap 210 also includes an end surface 214 that covers an end of the tubular portion of graphene. The end surface of graphene is bonded to the tubular portion of graphene to form a contiguous end cap of graphene. A variety of techniques for exposing just and end portion 208 of optic fiber 200 and cladding 206 are feasible. For example, a length of optic fiber 200 and cladding 206 may be contained within a nickel container having an opening of sufficient width to allow end portion 208 to extend out through the nickel container. The nickel container containing the length of optic fiber 200 and cladding 206 are then exposed to electron-beam evaporation to deposit copper film 202 onto cladding 206. Copper film 200 functions as a sacrificial layer that de-wets and evaporates from silica cladding 206 during the CVD process. The nickel container containing the length of optic fiber 200 and cladding 206 are then placed within a CVD chamber for deposition of graphene. As nickel has a melting point of 1453° C., the nickel container maintains is structure without change during the 1000° C. CVD process.

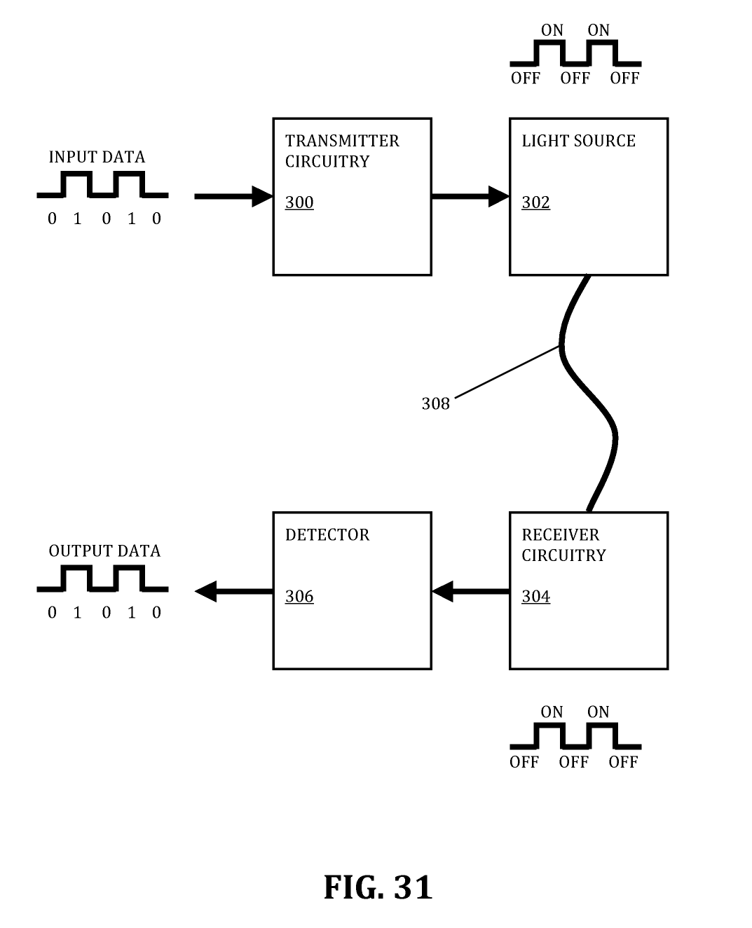

FIG. 31 illustrates an opto-electronic circuit utilizing a graphene coated optic fiber 308. Input data is received by transmitter circuitry 300. Transmitter circuitry 300 controls a light source 302 to transmit light signals across optic fiber 308. In a preferred embodiment, light source 302 is a deep ultraviolet LED having a wavelength of 245 nm and power of 30-70 μW having an AlGaN structure. An exemplary optic cable 308 is of the form shown in FIG. 22 that includes a silica optic fiber 200 encapsulated by a graphene capsule 204. The silica optic fiber 200 in this example has a diameter of 250 nm to 400 nm. As the wavelength of the UV light is 245 nm, graphene capsule 204 functions as a cladding layer due to the fact that at a wavelength of 245 nm, graphene has an index of refraction that is less than silica as shown by FIG. 18. Light source 302 is turned ON and OFF corresponding to the input data to transmit a signal across optic cable 308. A receiver circuit 304 receives the deep UV signals emitted by deep UV LED 302. Receiver circuit 304 receives the light impulses signifying the input data signal. Detector circuit 306 converts the received optical signal into output data.

While the invention has been shown and described with reference to a particular embodiment thereof, it will be understood to those skilled in the art, that various changes in form and details may be made therein without departing from the spirit and scope of the invention.

I claim:

1. A graphene coated optic-fiber, comprising:
a silica optic fiber, and
a tubular layer of graphene surrounding a length of said optic fiber, said tubular layer of graphene being deposited on said optic fiber through a Chemical Vapor Deposition (CVD) process.

2. The graphene coated optic-fiber of claim 1, wherein said tubular layer of graphene comprises multiple layers of graphene.

3. The graphene coated optic-fiber of claim 1, wherein said silica optic fiber has a first end surface, said first end surface being covered with a first graphene sheet deposited through said Chemical Vapor Deposition (CVD) process.

4. The graphene coated optic-fiber of claim 3, wherein said silica optic fiber has a second end surface, said second end surface being covered with a second graphene sheet deposited through said Chemical Vapor Deposition (CVD) process, said first and second graphene sheets being attached to said tubular layer of graphene via carbon-carbon bonds, thereby encapsulating said silica optic fiber in a graphene capsule.

5. The graphene coated optic-fiber of claim 1, further comprising silica cladding, said silica cladding surrounding said silica optic fiber, said tubular layer of graphene surrounding said silica cladding.

6. The graphene coated optic-fiber of claim 5, wherein said optic fiber and said silica cladding have coplanar end-surfaces, said coplanar end surfaces being covered with planar sheets of graphene deposited through said Chemical Vapor Deposition (CVD) process.

7. The graphene coated optic-fiber of claim 6, wherein said planar sheets of graphene are attached to said tubular layer of graphene via carbon-carbon bonds, thereby encapsulating said silica optic fiber and said silica cladding in a graphene capsule.

8. The graphene coated optic-fiber of claim 1, wherein said tubular layer of graphene functions as cladding layer around said silica optic fiber, said silica optical fiber carrying a wavelength of light such that said graphene has an index of refraction n for said wavelength of light that is less than the index of refraction n for silica.

9. The graphene coated optic-fiber of claim 1, wherein said silica optic fiber is a nanofiber.

10. A graphene coated optic-fiber, comprising an optic-fiber encapsulated in a graphene capsule.

11. The graphene coated optic-fiber of claim 10, wherein said optic fiber is a silica optic-fiber, wherein said graphene capsule is formed through depositing graphene on said silica optic-fiber through a Chemical Vapor Deposition (CVD) process.

12. The graphene coated optic-fiber of claim 11, further comprising silica cladding, wherein said silica cladding cylindrically surrounds said silica optic-fiber along its length within said graphene capsule.

13. The graphene coated optic-fiber of claim 10, wherein said optic fiber is formed of halide-chalcogenide glass, wherein said graphene capsule is formed over said optic fiber made of halide-chalcogenide glass by a microwave plasma CVD system.

14. The graphene coated optic-fiber of claim 10, wherein said graphene capsule functions as a cladding layer around said silica optic fiber.

15. The graphene coated optic-fiber of claim 10, wherein said graphene capsule is formed of multiple layers of graphene.

16. The graphene coated optic-fiber of claim 10, wherein said graphene capsule is formed a single layer of graphene.

17. A graphene coated optic-fiber, comprising:
an optic-fiber having an end portion including an end surface and a length of said optic-fiber near the end surface; and
a graphene end-cap covering the end portion of said optic fiber.

18. The graphene coated optic-fiber of claim 17, wherein said graphene end cap comprises:
a tubular section of graphene surrounding an end portion of said optic-fiber; and
an end surface portion of graphene that seals off an end of said tubular section of graphene, thereby forming a contiguous cap.

19. The graphene coated optic fiber of claim 18, wherein said tubular section of graphene is bonded to said end portion of graphene by carbon-carbon bonds.

20. The graphene coated optic fiber of claim 19, wherein said optic fiber is silica, wherein said graphene end cap is formed through a Chemical Vapor Deposition (CVD) process on said silica.
